(19) United States
(12) Patent Application Publication
(10) Pub. No.: US 2015/0137019 A1
(43) Pub. Date: May 21, 2015

(54) CONTROL VALVE STRUCTURE OF PLASTIC FAUCET

(71) Applicant: Gary Wu, CHANGHUA (TW)

(72) Inventor: Gary Wu, CHANGHUA (TW)

(21) Appl. No.: 14/085,315

(22) Filed: Nov. 20, 2013

(51) Int. Cl. F16K 27/04; F16K 27/12; F16K 3/24

(52) U.S. Cl. CPC F16K 27/041; F16K 3/243; F16K 27/12
USPC 251/286

(57) ABSTRACT

A plastic control valve is connected to a plastic tube body to control water output. The tube body has a receiving space, inner portion of the receiving space has inner threads, and at least one stopping block is protrudingly formed at a bottom surface of the receiving space, wherein said control valve has a valve body, a valve cover, and at least a wedging block formed at an outer portion of the valve body, wherein the valve body is disposed into the receiving space of the valve shell, and the wedging block and stopping block are rotatably secured with each other, wherein the valve cover has outer threads formed at an outer surface thereof to engage with the inner threads of the valve shell to eliminate squeeze between the tube body and valve cover due to thermal expansion and retraction to further increase the stability of the control valve.

### FIELD OF THE INVENTION

The present invention relates to a faucet structure, and more particularly to a control valve structure of a plastic faucet used in boreal regions.

### BACKGROUND OF THE INVENTION

A conventional plastic control valve structure in a faucet is shown in FIGS. 10 and 11. The control valve A has a valve body 40, a valve base 50, a stop member 60 and a cap 70. The entire control valve A is made by plastic, wherein the valve body 40 has a valve space 43 between a water inlet tube 41 and a water outlet tube 42, and two recessed slots 431 are formed at the inner edge of the valve space 43. Also, outer threads 432 are formed outside the valve space 43 and the valve base 50 is disposed in the valve space 43 of the valve body 40, and a spring 51 and a sleeve body 52 are disposed at the water inlet end 41. A shaft hole 61 is formed at the center of the stop member 60, and two protruding blocks 62 are protrudingly formed at the outer surface of the stop member 60. The stop member 60 covers the valve base 50, and the outer surface of the stop member 60 is squeezed into the valve space 43 of the valve body 40, so that the protruding blocks 62 are wedged in the recessed slot 431. Namely, the valve body 40 and the stop member 60 are conjugated in a tightened manner. Inner threads 71 are formed at the inner portion of the cap 70, and a stopping ring 72 is protrudingly formed at one end of the inner threads 71. The cap 70 is conjugated with the valve body 40 through the inner threads 71 and outer threads 432, so the stopping ring 72 of the cap 70 is disposed at an upper portion of the stop member 60, and the valve base 50 can be used for switching water input and output.

However, the outer surface of the faucet is exposed in the boreal regions with low temperature, the plastic stop member and the cap 70 would be retracted due to low temperature, but hot water flows in the valve space 43 to cause thermal expansion to reduce the gap between the plastic cap 70 and stop member 60. The stop member 60 would expand to squeeze the plastic cap 70 and the plastic cap 70 may be broken. The plastic cap 70 uses inner threads to secure in the outer portion of the valve body 40, and the plastic cap 70 may lose its resilience due to low temperature and may be broken to cause water leakage. More seriously, the stop member 60 and the valve base 50 may shoot out to cause flooding. Therefore, it is apparent that the control valve A cannot be used in the boreal regions with low temperature.

Moreover, conventional control valves utilize the rotation of the valve cover to restrict and control the position of the switch of the faucet. As disclosed in U.S. Pat. No. 4,577,835, the valve body is inside the tube body, and one end of the valve body has an integral stem extending out from the valve body. A stopping unit is disposed at the integral stem and a nut is used to lock at outer threads of the tube body. When the handle is rotated to drive the integral stem to control the water output, the stopping unit is used to stop the handle to restrict the position of the valve body. The control valve disclosed above is disadvantageous because when the outer surface of the faucet is in the boreal regions with low temperature, the nut would be retracted due to low temperature. Also, hot water flowing inside the tube body would cause thermal expansion of the stopping unit to reduce the gap between the stopping unit and the nut, so the stopping unit may break the nut to cause leakage. Furthermore, rotation of the handle may collide and damage the stopping unit, so the stopping unit cannot effectively generate the restricting effect.

### SUMMARY OF THE INVENTION

The present invention provides a control valve structure of a plastic faucet, wherein the control valve is made by plastic and can be used in boreal regions. The control valve is connected to a plastic tube body to control the on/off of the water output, wherein the tube body has a receiving space, inner portion of the receiving space has inner threads, and at least one stopping block is protrudingly formed at a bottom surface of the receiving space. A water inlet tube is located at one end of the receiving space of the tube body, while a water outlet tube is located at the other end thereof, and the water inlet tube and the water outlet tube are perpendicular. The control valve has a valve body and a valve cover, and at least a wedging block is formed at an outer portion of the valve body. The valve body is disposed into the receiving space of the tube body, and the wedging block and the stopping block are rotatably secured with each other. A spring and a sealing gasket are disposed between the water inlet tube and the valve body, and the spring is disposed against the sealing gasket to prevent leaking between the water inlet tube and the valve body. The valve body has an integral stem extending toward the receiving space, and the valve cover has a through hole at center portion thereof to cover the integral stem. The valve cover has outer threads are formed at an outer surface thereof, and the outer threads engage with the inner threads of the tube body. The valve cover also has a teeth ring that has an inner teeth ring and an outer teeth ring, and a teeth section is formed at least at the outer surface of the valve cover, wherein the inner teeth ring of the teeth ring engages with the teeth section of the valve cover and the outer teeth ring of the teeth ring is used to securely positioned outside to secure the valve cover and prevent it from falling off. A recessed slot is formed between the outer threads of the valve cover and the teeth section, and a sealing ring is disposed at the recessed slot, and the sealing ring is disposed between the tube body, valve cover and teeth ring to achieve the results of anti-leaking. Also, upper portion of the teeth ring of the valve cover has a ring cover, which is disposed against the teeth ring to form an axially secured position. In summary, with the outer threads engaging with the inner threads, the squeeze between the tube body and the valve cover due to thermal expansion and retraction can be eliminated to increase the stability of using the control valve.

The primary object of the present invention is that the receiving space has the inner threads that can be used to engage with the outer threads of the valve cover, so when the thermal expansion and retraction occurs, the inner threads and outer threads still securely engage with each other, and the valve cover would not fall off from the tube body due to water pressure to increase the stability of the plastic control valve when used in boreal regions.

The second object of the present invention is that the stopping block is formed in the receiving space of the tube body and used to block the wedging block of the valve body to restrict the rotation angle of the valve body to achieve the goal of water control. Also, the valve body does not use the valve cover to restrict its rotation angle, so the outer threads of the valve cover and the inner threads of valve body are unlikely to be disengaged to increase the stability of the installation.

The third object of the present invention is that the valve cover has a teeth ring that has an inner teeth ring and an outer teeth ring, and a teeth section is formed at least at the outer surface of the valve cover, wherein the inner teeth ring of the teeth ring engages with the teeth section of the valve cover and the outer teeth ring of the teeth ring is used to securely positioned outside to secure the valve cover and prevent it from falling off.

### BRIEF DESCRIPTION OF THE DRAWINGS

FIG. 1 illustrates a three-dimensional view of the present invention.

FIG. 2 illustrates an exploded view of the structure in the present invention.

FIG. 3 illustrates another three-dimensional view of the present invention.

FIG. 4 illustrates a sectional view of the present invention.

FIG. 5 illustrates a sectional view along water stopping position A-A in the present invention.

FIG. 6 illustrates a sectional view along water output position A-A in the present invention.

FIG. 7 is a schematic view of the present invention when in use.

FIG. 8 illustrates a sectional view of the present invention when in use.

FIG. 9 illustrates a sectional view of the present invention along line B-B.

FIG. 10 illustrates a three-dimensional view of a conventional control valve.

FIG. 11 illustrates a sectional view of the conventional control valve.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

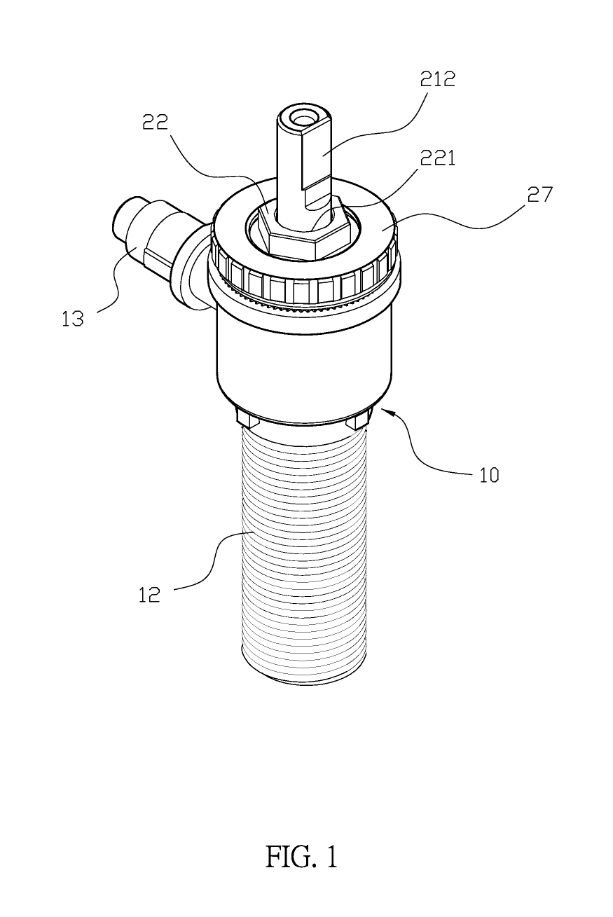

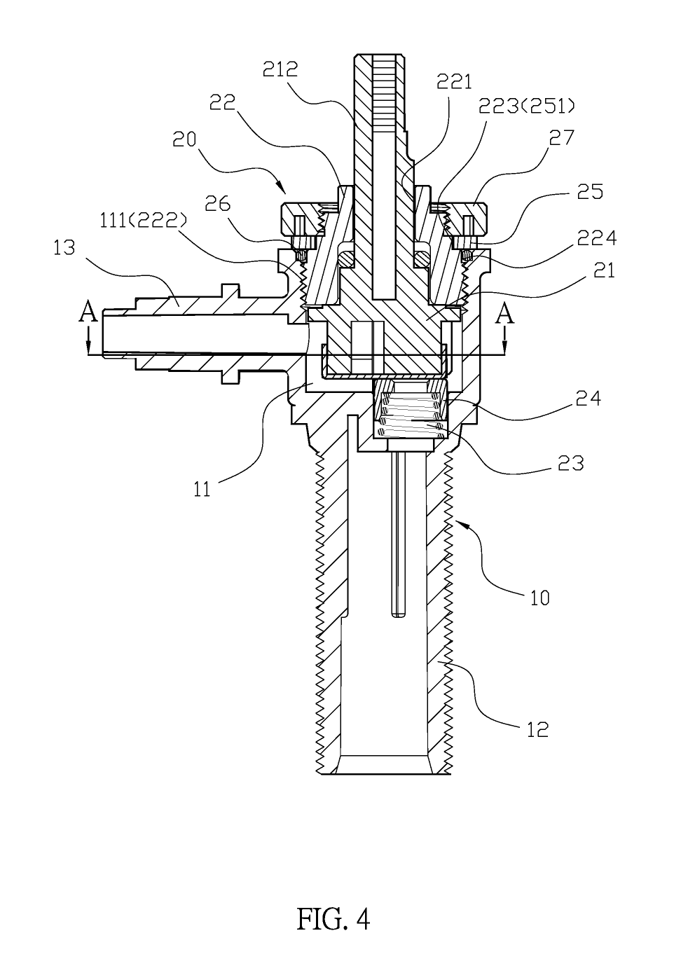

Referring to FIGS. 1 to 3, a control valve structure of a plastic faucet, wherein the control valve 20 is made by plastic and can be used in boreal regions. The control valve 20 is connected to a plastic tube body 10 to control the on/off of the water output, wherein the tube body 10 has a receiving space 11, inner portion of the receiving space 11 has inner threads 111, and at least one stopping block 112 is protrudingly formed at a bottom surface of the receiving space 11. A water inlet tube 12 is located at one end of the receiving space 11 of the tube body 10, while a water outlet tube 13 is located at the other end thereof, and the water inlet tube 12 and the water outlet tube 13 are perpendicular. The control valve 20 has a valve body 21 and a valve cover 22, and at least a wedging block 211 is formed at an outer portion of the valve body 21. The valve body 21 is disposed into the receiving space 11 of the valve shell 10, and the wedging block 211 and the stopping block 112 are rotatably secured with each other. A spring 23 and an sealing gasket 24 (see FIG. 4) are disposed between the water inlet tube 12 and the valve body 21, and the spring 23 is disposed against the sealing gasket 24 to prevent leaking between the water inlet tube 12 and the valve body 21. The valve body 21 has an integral stem 212 extending toward the receiving space 11, and the valve cover 22 has a through hole 221 at center portion thereof to cover the integral stem 212. The valve cover 22 has outer threads 222 are formed at an outer surface thereof, and the outer threads 222 engage with the inner threads 111 of the valve shell 10. The valve cover 22 also has a teeth ring 25 that has an inner teeth ring 251 and an outer teeth ring 252, and a teeth section 223 is formed at least at the outer surface of the valve cover 22, wherein the inner teeth ring 251 of the teeth ring 25 engages with the teeth section 223 of the valve cover 22 and the outer teeth ring 252 of the teeth ring 25 is used to securely positioned outside to secure the valve cover 22 and prevent it from falling off. A recessed slot 224 is formed between the outer threads 222 of the valve cover 22 and the teeth section 223, and a sealing ring 26 is disposed at the recessed slot 224, and the sealing ring 26 is disposed between the tube body 10, valve cover 22 and teeth ring 25 to achieve the results of anti-leaking. Also, upper portion of the teeth ring 25 of the valve cover 22 has a ring cover 27, which is disposed against the teeth ring 25 to form an axially secured position. In summary, with the outer threads 222 engaging with the inner threads 111, the squeeze between the tube body 10 and the valve cover 22 due to thermal expansion and retraction can be eliminated to increase the stability of using the control valve 20.

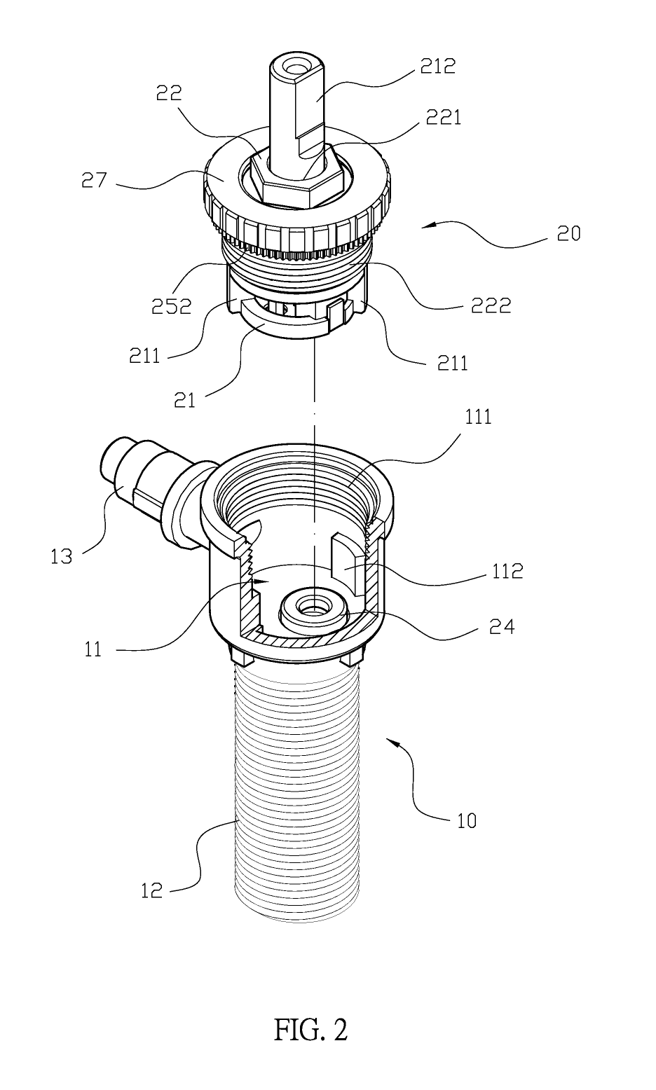

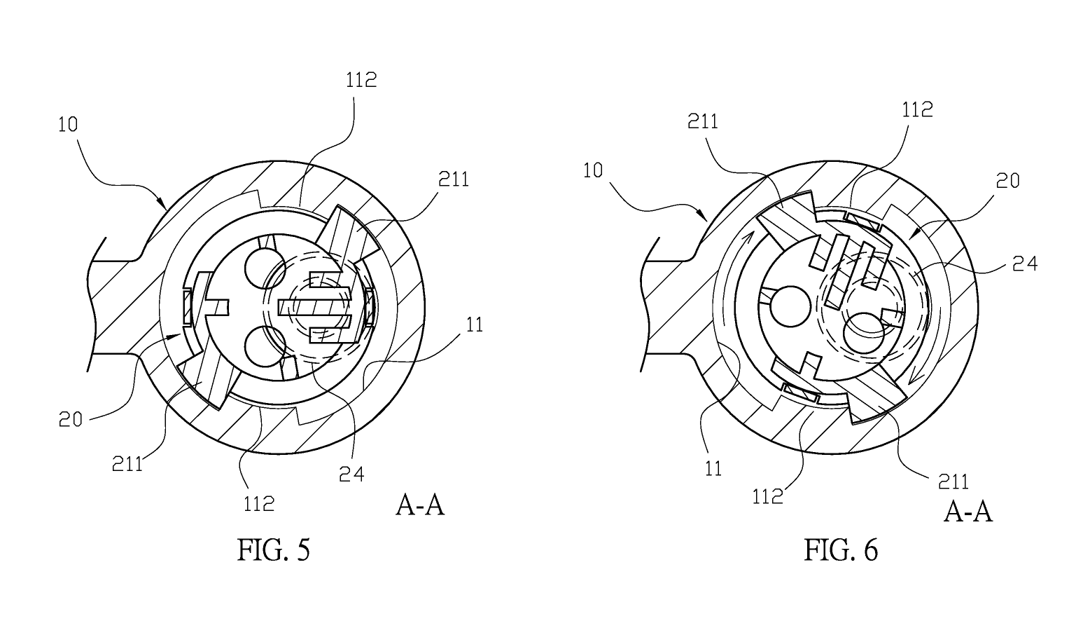

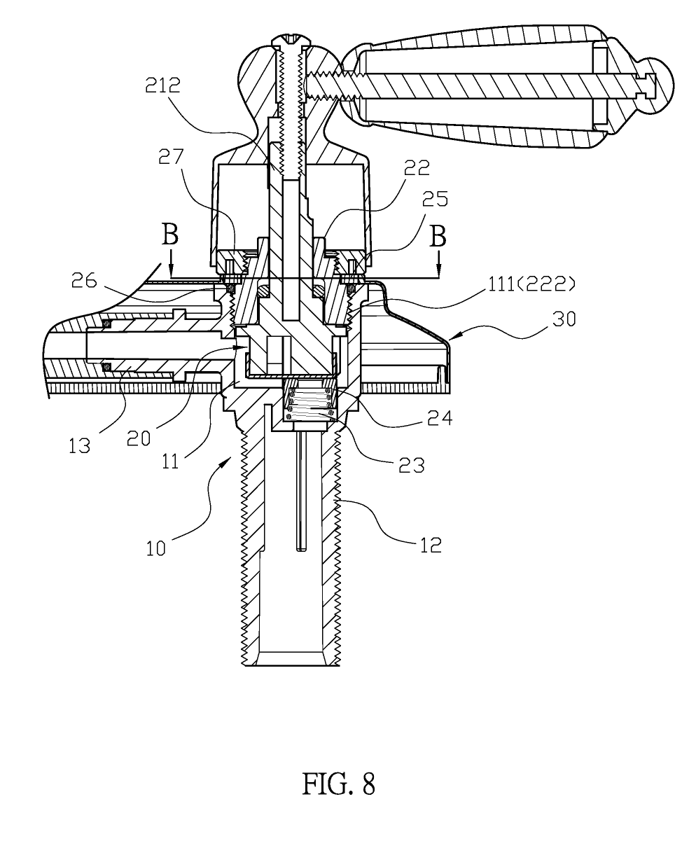

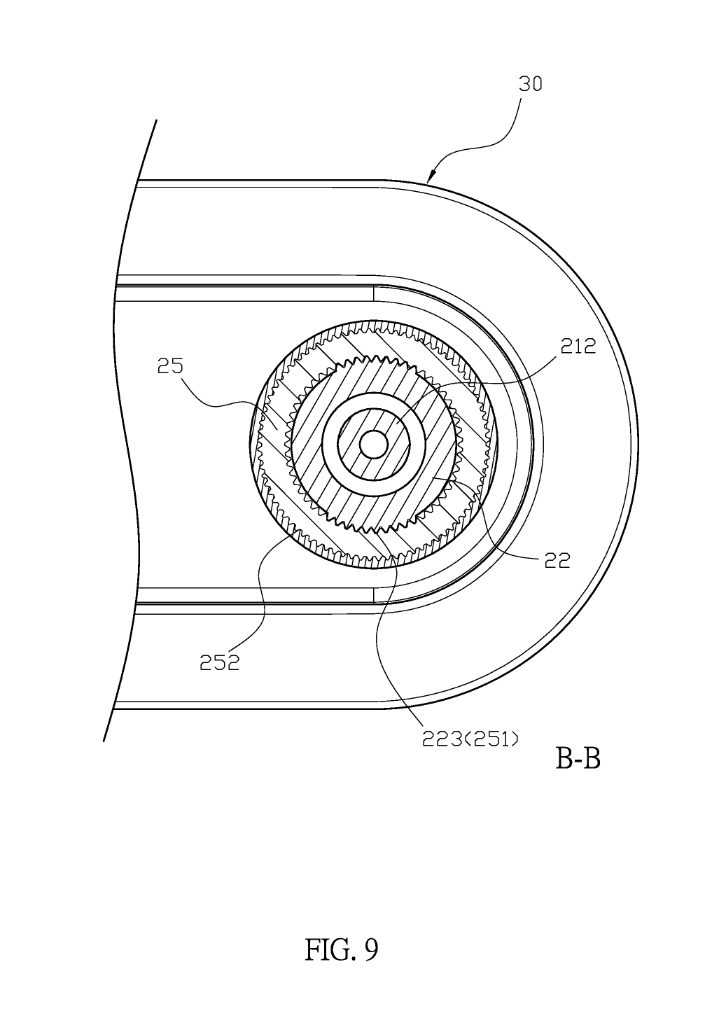

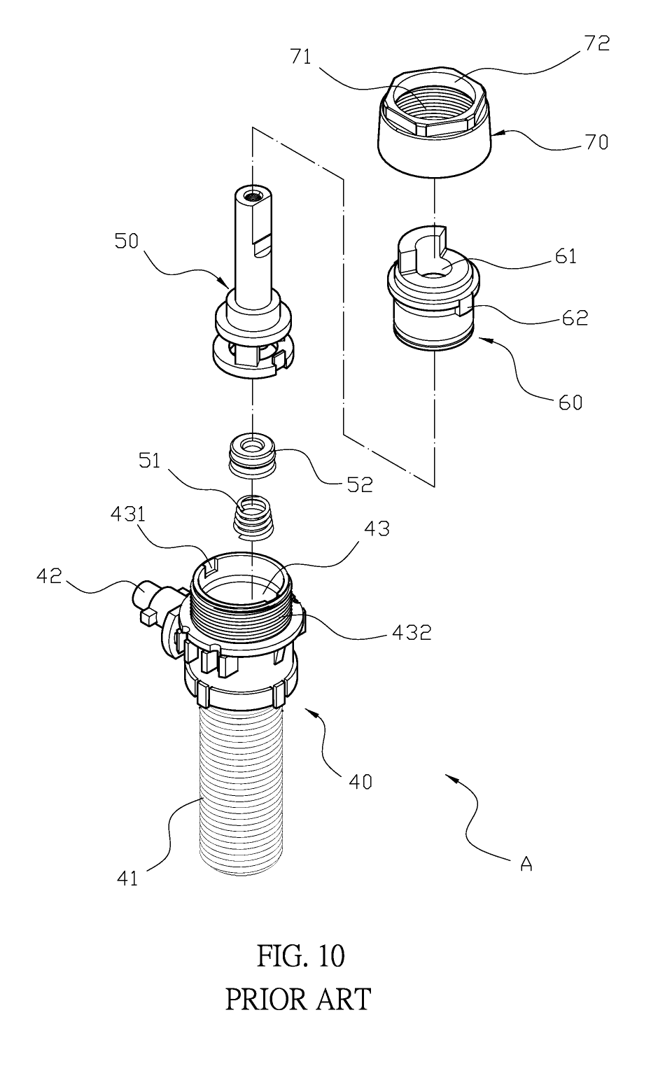

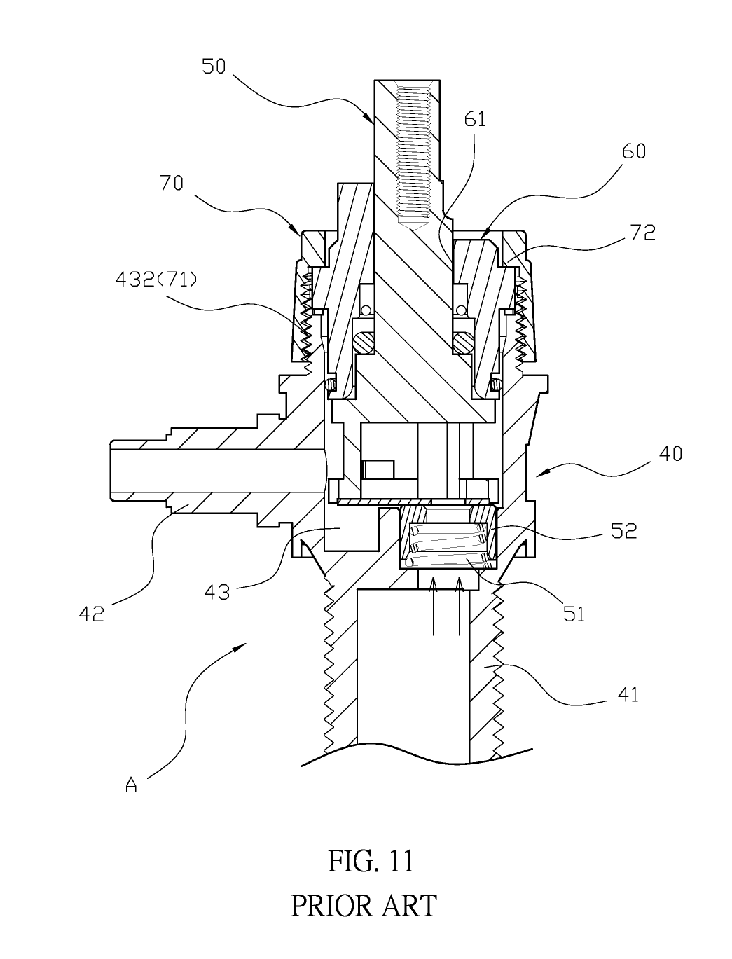

Referring to FIGS. 2 to 4 regarding the structure of the present invention, the spring 23 and the sealing gasket 24 are inserted into the receiving space 11 of the tube body 10, and one end of the spring 23 is disposed against the junction of the water inlet tube 12 and the receiving space 11, while the sealing gasket 24 is disposed at the other end of the spring 23. The control valve 20 is disposed into the receiving space 11 of the tube body 10 through the valve body 21, so that the valve base 22 can press on the sealing gasket 24 and stop the communication of the water inlet tube 12 and water outlet tube 13. The integral stem 212 is protruding out the receiving space 11 and passes through the through hole 221 of the valve cover 22. The outer threads 222 of the valve cover 22 engage with the inner threads 111 of the tube body 10 to restrict the valve base 22 in the receiving space 11 of the tube body 10. Thus, the valve body 21 can only rotate in the receiving space 11, and the wedging block 211 and stopping block 112 are used to restrict the valve body 21. The sealing ring 26 is disposed at the recessed slot 224 of the valve cover 22, and the sealing ring 26 is clamped between the tube body 10 and the valve cover 22. Also, the valve cover 22 has the teeth ring 25, and the inner teeth ring 251 of the teeth ring 25 engages with the teeth section 223 of the valve cover 22, so the outer teeth ring 252 of the teeth ring 25 can form a secured position outside (as shown in FIGS. 8 and 9) to prevent the valve cover 22 from falling off. Finally, the ring cover 27 is locked on the valve cover 22 and the ring cover 27 is used to press on the teeth ring 25. Referring to FIGS. 5 and 6, when rotating the integral stem 21 of the control valve 20, the integral stem 21 can be used as a switch to control the water inlet tube 12 and water outlet tube 13 to further control the water flow. The stopping block 112 is formed in the receiving space 11 of the tube body 10 and used to block the wedging block 211 of the valve body 21 to restrict the rotation angle of the valve body 21 to achieve the goal of water control. Also, the valve body 21 does not use the valve cover 22 to restrict its rotation angle, so the outer threads 222 of the valve cover 22 and the inner threads 111 of valve body 10 are unlikely to be disengaged to increase the stability of the installation.

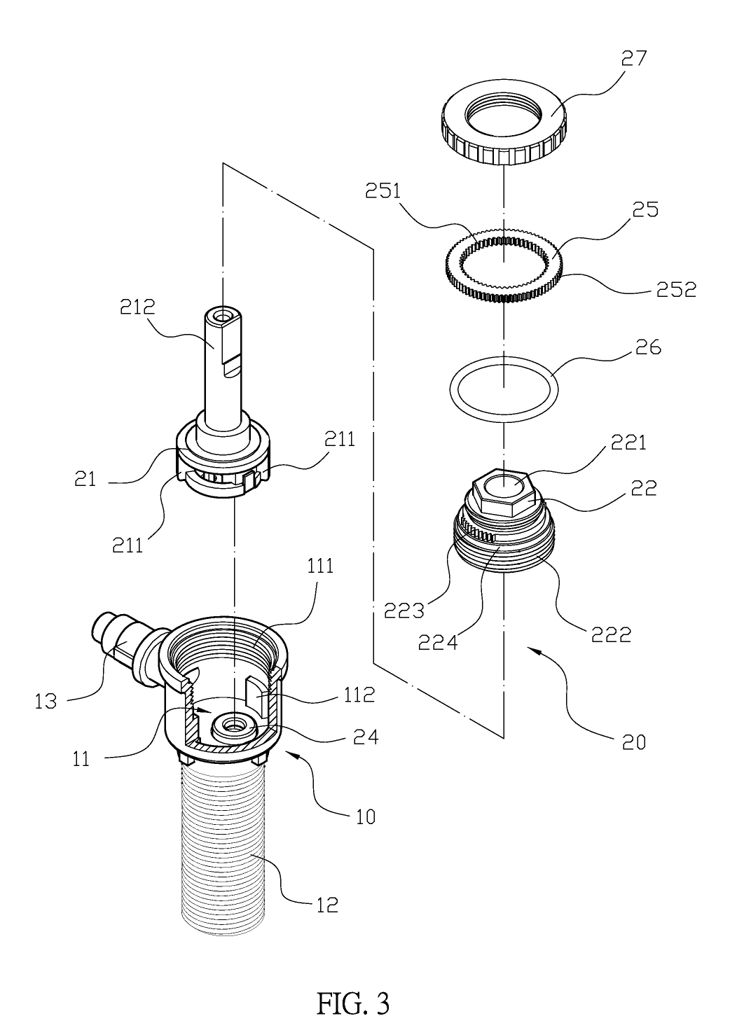

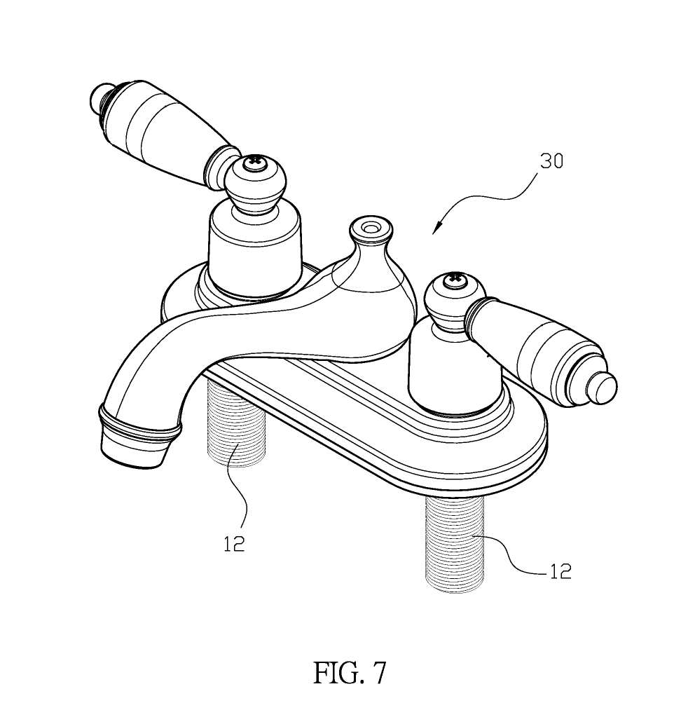

Referring to FIGS. 3, 7 and 8, the control valve 20 is made by plastic, so it is easy to manufacture and the manufacturing cost is thus reduced. Also, it can be used in boreal regions. The outer surface of the faucet 30 is exposed at boreal regions with low temperature and the plastic valve cover 22 would contract at low temperature. However, hot water flows in the water inlet tube 12 and water outlet tube 13 which would lead to thermal expansion to enlarge the gap between the tube body 10 and the valve cover 22. Thus, the receiving space 11 has the inner threads 111 that can be used to engage with the outer threads 222 of the valve cover 22, so when the thermal expansion and retraction occurs, the inner threads 111 and outer threads 222 still securely engage with each other, and the valve cover 22 would not fall off from the tube body 10 due to water pressure. Furthermore, with the engagement of the inner threads 111 and outer threads 222, the valve cover 22 is secured in the receiving space 11 of the tube body 10 to increase the conjugating strength, which prevent the valve cover 22 from separation due to material aging and enhance the stability of the plastic control valve 20 when it is used in boreal regions.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A plastic control valve structure in a faucet, said control valve made by plastic and used in boreal regions and said control valve connected to a plastic tube body to control water output, wherein the tube body has a receiving space, inner portion of the receiving space has inner threads, and at least one stopping block is protrudingly formed at a bottom surface of the receiving space, wherein said control valve has a valve body, a valve cover, and at least a wedging block is formed at an outer portion of the valve body, wherein the valve body is disposed into the receiving space of the valve shell and the wedging block and the stopping block are rotatably secured with each other, and an integral stem extends toward the receiving space, wherein the valve cover has a through hole at center portion thereof to cover the integral stem, and the valve cover has outer threads are formed at an outer surface thereof, and the outer threads engage with the inner threads of the valve shell to eliminate squeeze between the tube body and the valve cover due to thermal expansion and retraction to further increase the stability of using the control valve.

2. The plastic control valve structure in a faucet of claim 1, wherein the valve cover also has a teeth ring that has an inner teeth ring and an outer teeth ring, and a teeth section is formed at least at the outer surface of the valve cover, wherein the inner teeth ring of the teeth ring engages with the teeth section of the valve cover and the outer teeth ring of the teeth ring is used to securely positioned outside to secure the valve cover and prevent it from falling off.

3. The plastic control valve structure in a faucet of claim 2, wherein a recessed slot is formed between the outer threads of the valve cover and the teeth section and a sealing ring is disposed at the recessed slot, and the sealing ring is disposed between the valve shell, valve cover and teeth ring to achieve the results of anti-leaking.

4. The plastic control valve structure in a faucet of claim 2, wherein upper portion of the teeth ring of the valve cover has a ring cover, which is disposed against the teeth ring to form an axially secured position.
